(19) United States
(12) Patent Application Publication
(10) Pub. No.: US 2017/0300065 A1
(43) Pub. Date: Oct. 19, 2017

(54) AUTOMATIC RECOVERY SYSTEMS AND METHODS FOR UNMANNED AIRCRAFT SYSTEMS

(71) Applicant: Latitude Engineering, LLC, Tucson, AZ (US)

(72) Inventors: Jason Michael K. Douglas, Tucson, AZ (US); Justin Armer, Tucson, AZ (US); Carlos Murphy, Tucson, AZ (US)

(73) Assignee: Latitude Engineering, LLC, Tucson, AZ (US)

(21) Appl. No.: 15/131,891

(22) Filed: Apr. 18, 2016

(51) Int. Cl. G05D 1/06; B64C 29/00; B64C 39/02

(52) U.S. Cl. CPC G05D 1/0676; B64C 39/024; B64C 29/0025; B64C 2201/108; B64C 2201/141; B64C 2201/104

(57) ABSTRACT

An aircraft, such as an unmanned aircraft, can include a forward propulsion system comprising one or more engines and one or more rotors coupled to a corresponding engine; a vertical propulsion system comprising one or more vertical propulsion engines and one or more corresponding rotors coupled thereto; a sensor package comprising one or more sensors to detect an operating parameter of the aircraft. It may further include an automatic recovery system that includes an input coupled to the sensor package; an output coupled to an aircraft controller; a processor to monitor one or more operating parameters of the aircraft, detect a failure of the forward propulsion system based on the operating parameters, and transition the aircraft to the vertical propulsion system for landing.

### TECHNICAL FIELD

The disclosed technology relates generally to aircraft control systems, and more particularly, some embodiments relate to automatic recovery systems and methods for unmanned aircraft systems.

### DESCRIPTION OF THE RELATED ART

Unmanned aircraft have become ubiquitous in today's society. Their importance and value has grown dramatically in recent years, leading to widespread adoption in commercial, military and consumer market sectors. Part of the reason for their popularity is their low cost and small form factor as compared to piloted aircraft. However, the small engines used in various Unmanned Aircraft Systems have demonstrated a lower reliability as compared to piloted aviation engines. Also, because they don't transport people, drones are often pushed harder than piloted aircraft. This greater demand on the aircraft systems can lead to a decreased mean time between failure (MTBF).

Loss of a UAS can be brought about by any of a number of different failure modes, such as engine failure, flight system or mechanical failure, communications link failures, and operator error. However, engine failure is one of the more common, if not the primary cause of damage to or loss of small UAS and associated payloads. Although human lives are not typically at stake when a UAS fails, there are costs associated with such failure. These can include, for example, loss of the aircraft, loss of the payload, failure of the mission, and any collateral damage or losses. Accordingly, systems and methods for recovery in the event of failure can be of value to unmanned aircraft.

### BRIEF SUMMARY OF EMBODIMENTS

According to various embodiments of the disclosed technology systems and methods for automatic recovery to a landing configuration upon engine failure or other failure of unmanned aircraft are disclosed. In various embodiments, systems can be configured on board the aircraft, at the remote ground terminal, or both, to detect engine failure through a number of mechanisms and to initiate a recovery sequence in the event of a detected engine failure. In the case of a hybrid aircraft utilizing both a forward propulsion mechanism and a vertical takeoff and landing (VTOL) mechanism, the recovery sequence can include, for example, the creation and implementation of a recovery flight plan that includes transitioning the aircraft from a forward propulsion mode to a VTOL mode to enable VTOL landing. The system can be implemented to reconfigure the aircraft for a best glide (or other appropriate flight condition), create a landing plan within gliding range of the aircraft, initiate a landing sequence, and transition at landing from fixed-wing forward flight to a primarily VTOL configuration for vertical landing at a determined recovery location.

According to an embodiment of the disclosed technology an aircraft, includes a forward propulsion system includes a first engine and a first rotor coupled to the first engine; a vertical propulsion system includes a second engine and a second rotor coupled to the second engine; a sensor package includes one or more sensors to detect an operating parameter of the aircraft; and an automatic recovery system, which may include: an input coupled to the sensor package; an output coupled to an aircraft controller; and a processor to monitor one or more operating parameters of the aircraft, detect a failure of the forward propulsion system based on the operating parameters, and transition the aircraft to the vertical propulsion system for landing.

In various embodiments, the operating parameter includes at least one of RPM, altitude, airspeed, climb rate, and throttle setting. Detecting a failure may include, for example, at least one of detecting a loss of RPM from the first engine, detecting a loss of altitude or airspeed, detecting an inadequate climb rate, and detecting an abnormally high throttle setting for a flight condition.

In some embodiments, the processor may be configured to perform the operations of creating a landing plan for the aircraft up detection of a failure of the forward propulsion system. The processor may also be configured to configure the aircraft for compromised landing.

In various embodiments, the landing plan created for the aircraft may be created based on aircraft altitude and location at the time of creating the landing plan.

An unmanned aircraft system may include: an unmanned aircraft, a remote control system; and an automatic recovery system. The unmanned aircraft may include: a forward propulsion system includes a first engine and a first rotor coupled to the first engine; a vertical propulsion system includes a second engine and a second rotor coupled to the second engine; a sensor package includes one or more sensors to detect an operating parameter of the aircraft; an onboard aircraft controller that may include a first output coupled to the forward propulsion system and a second output coupled to the vertical propulsion system; and a first communication transceiver coupled to the aircraft controller and configured to communicate with a remote control system.

The remote control system may include: a second communication transceiver configured to communicate with the unmanned aircraft; and an aircraft control system communicatively coupled to the second communication transceiver; and The automatic recovery system may include: an input coupled to the sensor package; an output coupled to an aircraft controller; a processor to monitor one or more operating parameters of the aircraft, detect a failure of the forward propulsion system based on the operating parameters, and transition the aircraft to vertical propulsion system flight for landing.

The automatic recovery system may be part of the onboard aircraft controller, part of the aircraft control system of the remote control system, or part of both the onboard aircraft controller the aircraft control system of the remote control system.

The processor may also be configured to perform the operations of creating a landing plan for the aircraft upon detection of a failure of the forward propulsion system. The processor may further be configured to configure the aircraft for compromised landing.

The landing plan created for the aircraft may be created based on aircraft altitude and location at the time of creating the landing plan.

Detecting a failure may include at least one of detecting a loss of RPM from the first engine, detecting a loss of altitude or airspeed, detecting an in adequate climb rate, and detecting an abnormally high throttle setting for a flight condition.

In yet another embodiment a method for automatic recovery of an aircraft, includes: monitoring aircraft parameters; detecting a failure of a forward propulsion system of the aircraft based on the operating parameters; and transitioning the aircraft to a vertical propulsion system for landing. The operating parameter may include at least one of RPM, altitude, airspeed, climb rate, and throttle setting.

The method may further include creating a landing plan for the aircraft up detection of a failure of the forward propulsion system. The landing plan created for the aircraft may be created based on aircraft altitude and location at the time of creating the landing plan. Detecting a failure may include at least one of detecting a loss of RPM from the first engine, detecting a loss of altitude or airspeed, detecting an in adequate climb rate, and detecting an abnormally high throttle setting for a flight condition.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

Some of the figures included herein illustrate various embodiments of the disclosed technology from different viewing angles. Although the accompanying descriptive text may refer to such views as “top,” “bottom” or “side” views, such references are merely descriptive and do not imply or require that the disclosed technology be implemented or used in a particular spatial orientation unless explicitly stated otherwise.

FIG. 1 illustrates an example unmanned vertical take-off and landing (VTOL) aircraft with which embodiments of the technology disclosed herein may be implemented.

FIG. 2 is a diagram illustrating an example unmanned aircraft system in accordance with one embodiment of the systems and methods disclosed herein.

FIG. 3 is a diagram illustrating an example process for an automated aircraft recovery system in accordance with one embodiment of the systems and methods described herein.

FIG. 4 is a diagram illustrating an example process for an automatic recovery to a landing configuration in accordance with one embodiment of the systems and methods disclosed herein.

FIG. 5 is a diagram illustrating an example landing pattern in accordance with one embodiment of the systems and methods described herein.

The figures are not intended to be exhaustive or to limit the invention to the precise form disclosed. It should be understood that the invention can be practiced with modification and alteration, and that the disclosed technology be limited only by the claims and the equivalents thereof.

### DETAILED DESCRIPTION OF THE EMBODIMENTS

Embodiments of the technology disclosed herein are directed toward devices and methods for providing recovery for a drone, UAV or other Unmanned Aircraft System (UAS) in the event of failure. More particularly, the various embodiments of the technology disclosed herein relate to systems and methods for automatic recovery to a landing configuration upon engine failure of unmanned aircraft. In various embodiments, systems can be configured on board the aircraft, at the remote ground terminal, or both, to detect engine failure through a number of mechanisms and to initiate recovery sequence in the event of a detected engine failure. In the case of a hybrid aircraft utilizing both a forward propulsion mechanism and a vertical takeoff and landing (VTOL) mechanism, the system can be configured to reconfigure the aircraft for a best glide (or other appropriate flight condition), create a landing plan within gliding range of the aircraft, initiate landing sequence, and transition at landing from fixed-wing forward flight to a primarily VTOL configuration for vertical landing.

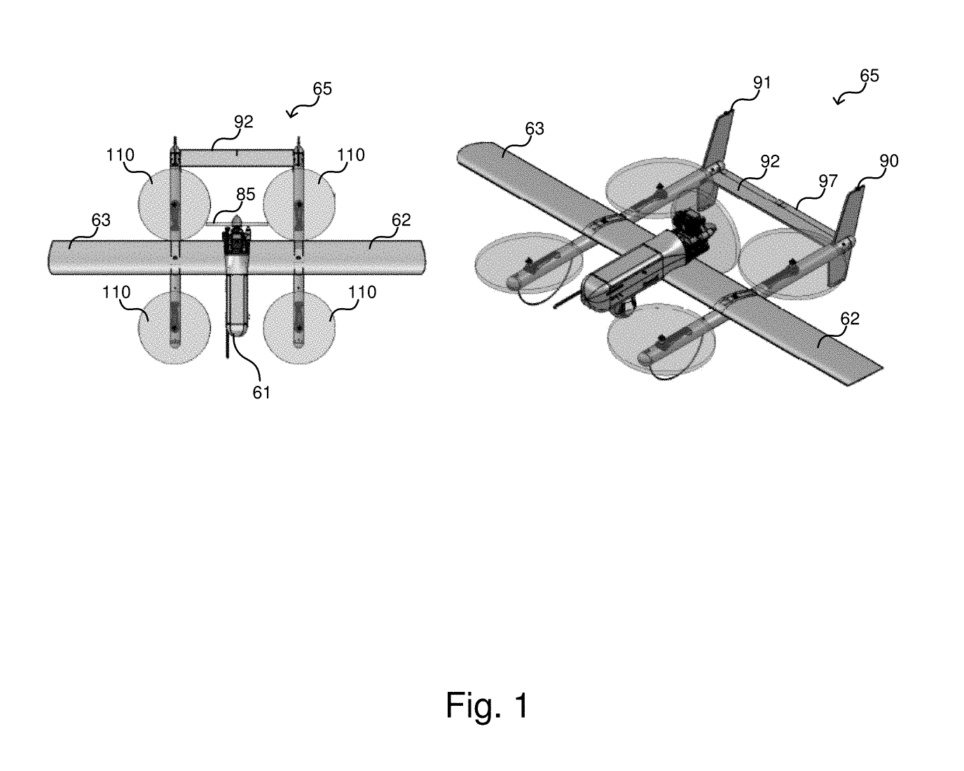

Before describing embodiments of the systems and methods in detail, it is useful to describe an example aircraft with which such systems and methods can be used. FIG. 1 is a diagram illustrating an example unmanned vertical take-off and landing (VTOL) aircraft with which the technology disclosed herein may be implemented. Referring now to FIG. 1, this example aircraft is a hybrid quadrotor aircraft having an airframe that includes fuselage 61, fixed left and right wings 62 and 63, a tail assembly or empennage 65. Also shown are left and right tail boom supports (not numbered for clarity of the illustration), and left and right head boom supports. Left and right wings 62 and 63 are fixed to fuselage 61 to form a fixed wing airframe.

Left wing 62 and right wing 63 are airfoils that produce lift to facilitate aircraft flight. During flight, air passing over the wing creates a region of lower-than-normal air pressure over top surfaces of left and right wings 62 and 63, with a higher pressure existing on the bottom surfaces of left and right wings 62 and 63. This results in a net upward force acting on left and right wings 62 and 63 to generate lift. Left wing 62 is applied to and extends from left side of fuselage 61 and right wing 63 is applied to and extends from right side of fuselage 61. Although not shown, a left aileron is pivotally retained at the rear of left wing 62 near its outer or distal extremity, and a right aileron is pivotally retained at the rear of right wing 63 near the outer or distal extremity of right wing 63.

Empennage 65 gives stability to the aircraft, and is located behind and in spaced-apart relation to the trailing extremity of fuselage 61. In this embodiment, empennage 65 is exemplary of a twin tail assembly or twin tail empennage may include left and right vertical stabilizers 90, 91, and a horizontal stabilizer 92 extending between left and right vertical stabilizers. The left and right vertical stabilizers 90, 91 extend upward from a rear of their corresponding left and right tail boom supports while the horizontal stabilizer 92 is retained between left and right tail boom supports. Rudders, not shown, may be pivotally retained on the trailing edge of left and right stabilizers 90, 91. An elevator 97 is pivotally retained on a rear of horizontal stabilizer 92.

This example aircraft is a hybrid craft including separate rotors for forward and vertical thrust. Particularly, this example is a hybrid quadrotor “X” configuration. Accordingly, this example illustrates a forward thrust rotor 85, which is mounted to the rear extremity of fuselage 61 in front of empennage 65. Forward thrust rotor 85, which provides forward thrust to aircraft 50, is typically powered by a forward propulsion engine, sometimes referred to as a main engine. This example uses a single forward thrust rotor mounted at the rear of the fuselage 61. However, the technology can be applied to aircraft using one or multiple thrust rotors mounted at other positions.

The example aircraft also includes a VTOL propulsion system, or simply a VTOL system, to provide vertical thrust for vertical takeoff and landing operations. This example is a quadrotor VTOL system including four VTOL thrust rotors 110 in a quadrotor “X” pattern for providing vertical lift and yaw control authority to the aircraft. In other applications, the technology disclosed herein may be applied to aircraft having a different quantity of VTOL thrust rotors, or thrust rotors at different locations. VTOL aircraft can include fixed-mount VTOL thrust rotors or pivot-mount VTOL thrust rotors. Forward thrust engines and vertical thrust engines can be internal combustion engines or electric motors or a combination of the two.

Having thus described an example aircraft with which one or more aspects of the disclosed technology can be implemented, various embodiments are now described. Although the disclosed technology may be described from time to time herein in terms of this example aircraft, one of ordinary skill in the art reading this disclosure will understand how aspects of the disclosed technology can be implemented with different aircraft are different aircraft configurations.

According to various embodiments of the technology disclosed herein, an automatic recovery system is provided to enable recovery of an unmanned aircraft to a landing configuration upon engine failure or other system malfunction. In applications such as a hybrid aircraft (an example of which is described above with reference to FIG. 1) having separate VTOL and forward propulsion systems, the automatic recovery system can be configured to initiate a powered, controlled recovery in the event of a main engine (forward-thrust engine) failure or other failure of the forward propulsion system.

When a main engine failure is detected, the recovery sequence is initiated to take over an attempt to safely land the aircraft. The automatic recovery system examines aircraft criteria such as, for example, altitude, location, weather, atmospheric conditions, and so on, and creates a landing plan for the aircraft. The landing sequence is executed, and during the last segment of the landing plan the automatic recovery system transitions the aircraft from a fixed-wing forward flight configuration to a primarily VTOL configuration.

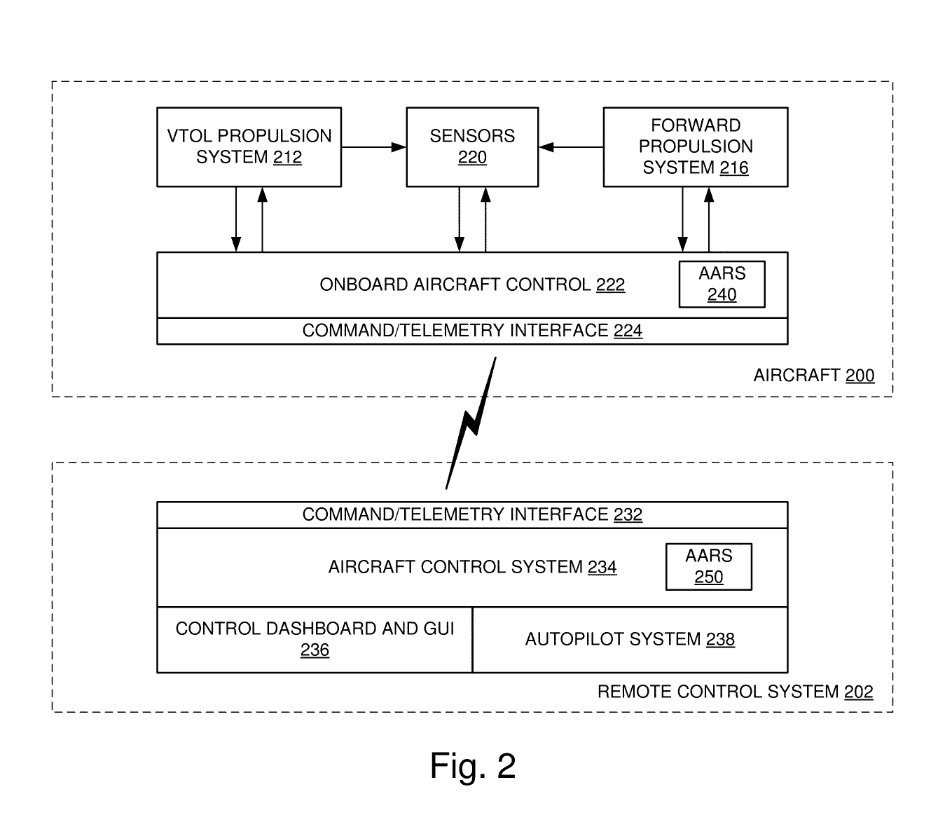

FIG. 2 is a diagram illustrating an example unmanned aircraft system in accordance with one embodiment of the systems and methods disclosed herein. The example in FIG. 2 includes an unmanned aircraft 200 and a remote control system 202 for the aircraft 200. In this example, aircraft 200 includes a VTOL propulsion system 212, a forward propulsion system 216, various sensors 220, and onboard aircraft control system 222, and a command/telemetry interface 224.

VTOL propulsion system 212 includes systems and components used for vertical takeoff and landing. This can include, for example, one or more rotors, corresponding engines or motors, and other systems associated with VTOL propulsion. In various embodiments, the rotor or rotors of VTOL propulsion system 212 are oriented horizontally or in an approximately horizontal configuration. The rotor or rotors of VTOL propulsion system 212 can be mounted in a fixed orientation, or can be movably mounted such that their orientation can be adjusted from the horizontal configuration. VTOL propulsion system 212 can include one or more inputs to receive data, commands, control information, or other information to operate or maintain the propulsion systems or components thereof. For example, a throttle control input can be provided to adjust the throttle setting for the propulsion system.VTOL propulsion system 212 can also include one or more outputs to send data and other information about the propulsion system to other instrumentalities such as, for example, onboard aircraft control system 222 or one or more sensors 220.

Forward propulsion system 216 includes one or more rotors, corresponding engines or motors, and other systems associated with forward propulsion. The rotor or rotors of forward propulsion system 216 are oriented vertically or in an approximately vertical configuration to provide forward or reverse thrust to the aircraft. The rotor or rotors of forward propulsion system 216 are generally mounted in a fixed orientation, but in some embodiments may be movably mounted such that their orientation can be adjusted from the vertical configuration. Forward propulsion system 216 can also include one or more outputs to send data and other information about the propulsion system to other instrumentalities such as, for example, onboard aircraft control system 222 or one or more sensors 220. Forward propulsion system 216 can include one or more inputs to receive data, commands, control information, or other information to operate or maintain the propulsion systems or components thereof. For example, a throttle control input can be provided to adjust the throttle setting for the propulsion system.

Sensors 220 can include one or more various sensors to sense operating parameters of the aircraft and its various systems and subsystems. For example, sensors 220 can include sensors such as temperature sensors, RPM sensors, airspeed sensors, altimeters, position determination systems (e.g. GPS or other position determination systems) vibration sensors, gyros, accelerometers, and so on. Sensors can accordingly sense conditions or other operating parameters of aircraft 200 and its various systems and subsystems. Although illustrated as a single block in this diagram, sensors 220 can include individual discrete sensors disposed in various positions about the aircraft to sense the appropriate parameters.

Command/telemetry interface 224 provides a communication interface to allow aircraft 200 to communicate, preferably two-way, with remote control system 202. Accordingly, command/telemetry interface 224 can include an antenna and a communication transceiver to provide wireless communications so they can receive command and control information from remote control system 202 as well as send data or other telemetry to remote control system 202.

Onboard aircraft control system 222 is provided to control the various components of the aircraft based on commands received from remote control system 202 (e.g., via the command/telemetry interface 224). Onboard aircraft control system 222 can also be configured to receive information from other aircraft components such as, for example, sensor data, and provide that information to command/telemetry interface 224 for transmission to remote control system 202.

Although the functional components of aircraft 200 (e.g., onboard aircraft control system 222, command/telemetry interface 224 and automatic aircraft recovery system 240) are partitioned in this example in the manner as illustrated in FIG. 2, it is noted that this partitioning is done for clarity of description and by way of example only. After reading this description, one of ordinary skill in the art will understand how different architectures or alternative partitioning can be used for systems of aircraft 200. Additionally, components such as processing devices, memory components, communications buses and so on can be shared among these multiple functional units. Indeed, in some applications, for example, a single microprocessor (whether single or multi-core) system can be used to implement the functions of onboard aircraft control system 222, and automatic aircraft recovery system 240, as well as portions command/telemetry interface 224, sensors 220, and even digital/electronic portions of the various propulsion systems.

Remote control system 202 in this example includes a command/telemetry interface 232, and aircraft control system 234 a control dashboard and user interface 236 and an autopilot system 238. Command/telemetry interface 232 provides a wireless communication interface to aircraft 200. In some embodiments, remote control system 202 can be used to command multiple aircraft, in which case command/telemetry interface 232 can provide a communication interface to multiple aircraft.

Control dashboard and GUI 236 provides a user interface to the remote pilot to allow the pilot to control one or more aircraft such as aircraft 200. Control dashboard and GUI 236 can be configured to provide visual, audible, and tactile feedback and information to the pilot regarding flight of the aircraft and various aircraft parameters. You can also include user input mechanisms to allow the pilot to control the aircraft remotely. These user input mechanisms can include, for example, buttons, switches, levers, joysticks, keys, touchscreen inputs, or other actuators to enable the pilot to provide input and adjust aircraft settings. This can allow the pilot to control, for example, throttle settings for the various propulsion systems, to adjust the rudder and ailerons, and so on.

Inputs from the user are interpreted by aircraft control system 234 to translate user inputs into commands for aircraft control. In some applications, this can be a translation of direct commands such as throttle inputs, rudder control, flap adjustment and so on. Control inputs can also include higher level commands such as rotation rate or rate over ground, etc, which can be translated into aircraft system control commands. These commands are communicated to aircraft 200 via command/telemetry interface 232 and command/telemetry interface 224. Functionality for aircraft control can be distributed among aircraft control system 234 and onboard aircraft control 222 as may be appropriate depending on the system configuration.

An autopilot system 238 can also be provided to control the aircraft via computerized or automated control with little or no input required by a human pilot. Although illustrated in this example as part of remote control system 202, part or all of the functionality of autopilot system 238 can be provided at aircraft 200. Although not illustrated, in some embodiments and onboard autopilot system can be included with the aircraft 200 to enable local autopilot control, which may ease the load on the command/telemetry interfaces.

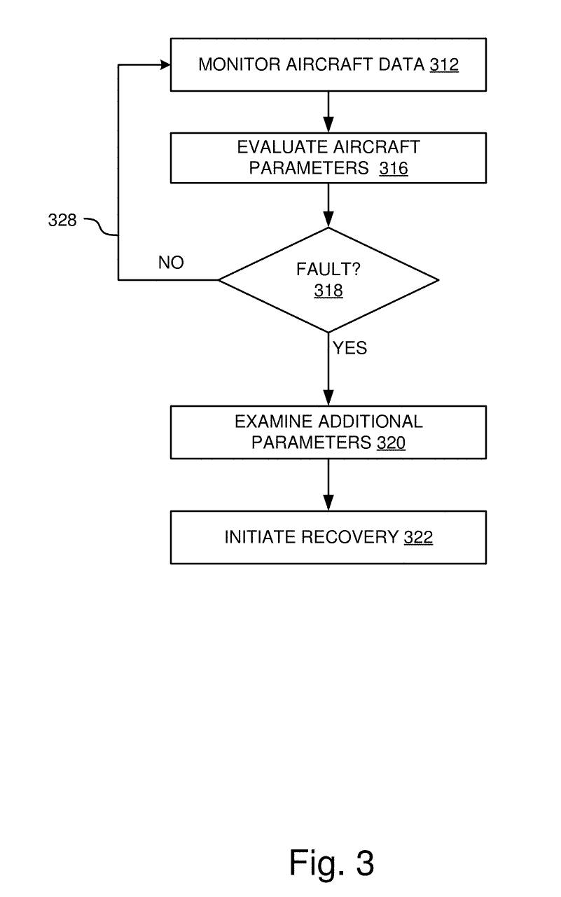

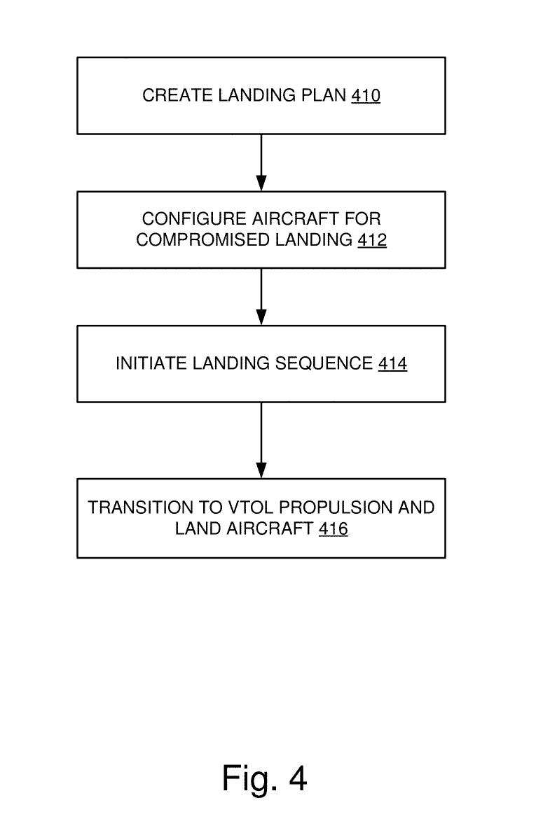

Also illustrated is an onboard automatic aircraft recovery system 240 and a remote automatic aircraft recovery system 250. An automatic aircraft recovery system can be included to coordinate or control automatic recovery of the aircraft to a landing configuration in the event of a system failure such as, for example, an engine or other propulsion system failure. Such an automatic aircraft recovery system can include an input to receive information about the aircraft, such as aircraft system data (e.g., sensor data), control data and flight data and can be configured to control the aircraft for recovery from a failure such as a failure of forward propulsion system 216. That is, the automatic aircraft recovery system can be configured to receive aircraft parameters, determine whether a fault condition has occurred requiring recovery, and if so initiating recovery which can include determining in implementing a recovery plan and transitioning the aircraft from a forward propulsion mode to a VTOL mode for landing. Examples of detection and recovery are described in further detail below with reference to FIGS. 3 and 4.

Although the functional components of remote control system 202 (e.g., aircraft control system 234, control dashboard and GUI 236, autopilot system 238, command/telemetry interface 232 and automatic aircraft recovery system 250) and aircraft 200 are partitioned in this example in the manner as illustrated in FIG. 2, it is noted that this partitioning is done for clarity of description and by way of example only. After reading this description, one of ordinary skill in the art will understand how different architectures or alternative partitioning can be used for aircraft 200 or remote control system 202. Additionally, components such as processing devices, memory components, communications buses, and so on can be shared among these multiple functional units. Indeed, in some applications, for example, a single microprocessor (whether single or multi-core) system can be used to implement the various described functions of remote control system 202 (e.g., aircraft control system 234, autopilot system 238, and automatic aircraft recovery system 250, as well as portions of control dashboard in GUI 236 and command/telemetry interface 232) or aircraft 200.

Although the automatic aircraft recovery system is illustrated as two modules in the form of onboard automatic aircraft recovery system 240 and remote automatic aircraft recovery system 250, this illustration is by way of example only and other configurations or architectures can be implemented. In the example illustrated in FIG. 2, the functionality of the automatic aircraft recovery system can be split or shared among onboard automatic aircraft recovery system 240 and remote automatic aircraft recovery system 250, or these 2 systems can be independent of one another with each being able to independently implement and execute a recovery plan in the event of failure. Additionally, redundancies can be built-in among these 2 systems so that one can provide backup support for the other and vice versa.

In another embodiment, the automated aircraft recovery system can be implemented on either aircraft 200 or remote control system 202 or a combination of both. In embodiments in which automated aircraft recovery system 250 is implemented on the remote control system 202, data about the status of the aircraft 200 is sent over the command/telemetry interface 232, allowing the aircraft control system to evaluate the state of aircraft 200. If engine failure or other emergency state is detected and the automated aircraft recovery system determines the need for automatic recovery, the corresponding set of waypoints and commands required to effect a recovery can be generated by automated aircraft recovery system 250 and sent to the aircraft for execution over the command/telemetry interface 232. In this manner, automated aircraft recovery system 250 can be implemented on remote control system 202 without the requirement to modify the software aboard the Aircraft. This may be advantageous to save testing and certification efforts. However, in the event of a loss of communications via command/telemetry interface 232, automated aircraft recovery system 250 may not be able to recover the aircraft.

In the case in which automated aircraft recovery system 240 is implemented on the aircraft 200, the data about the status of the aircraft 200 is received by automated aircraft recovery system 240 (e.g., from an onboard data bus or other communication interface), allowing onboard aircraft control 222 to evaluate the state of the aircraft. If engine failure or other emergency state is detected and automated aircraft recovery system 240 determines the need for automatic recovery, the corresponding set of waypoints and commands used to effect a recovery can be generated by automated aircraft recovery system 240 and used by onboard aircraft control 222 for execution over an onboard bus. The onboard bus may be a data transmission bus such as RS-232 serial, or may be an internal communications scheme implemented on a microprocessor, which may also house the onboard aircraft control algorithms. One advantage to having an automated aircraft recovery system 240 on board aircraft 200 is that the system can function autonomously to recover an aircraft in the event of a failure or interruption of the communications interface with remote control system 202.

FIG. 3 is a diagram illustrating an example process for an automated aircraft recovery system in accordance with one embodiment of the systems and methods described herein. With reference now to FIG. 3, at operation 312 an automatic aircraft recovery system monitors aircraft parameters. The aircraft parameters monitored can include, for example, engine RPM, airspeed, altitude, climb rate, throttle setting, engine temperature, fuel level, magneto performance, intake air flow, and so on. These parameters can be obtained from the various onboard or ground systems and sensors can be included to detect parameters and provide the data directly or indirectly to the automated aircraft recovery system. In various configurations, the automatic aircraft recovery system can be configured to use existing or customary sensors on an aircraft without requiring special or unique sensors to be added.

RPM data can include data from one or more engines (or motors) from the various propulsion systems of the aircraft, including a forward propulsion system, which may include a forward rotor and engine or motor. For example, a shaft encoder or other shaft speed sensor can be included with the rotor to detect rotations of the rotor. As another example, the frequency of the current/voltage used to power a motor can be another form of RPM sensor. However, if there is a problem with the motor, the actual RPM of the rotor may not be proportional to the frequency of the control signal driving a motor.

At operation 316, the parameters are monitored for detection of a fault. A fault that may trigger an automatic recovery can include, for example, failure of the forward propulsion system (e.g. main-engine failure), failure of the aircraft remote control system (e.g., leading to an inability of the remote operator to control the aircraft), or failure of the communication link from the remote control system to the aircraft. These failures can be detected in a number of different ways. For example, a detected loss of RPM when the RPM was previously healthy can indicate a failed engine. Similarly, RPM measurements inconsistent with throttle setting may also indicate an engine failure. This may be the case where for example the throttle position indicates a high power setting, but the RPM measurements indicate low-speed propeller rotations. There are also certain types of propeller failure that may be manifested as high-speed propeller rotations where the throttle position indicates a low-power setting. As yet one more example, the system can evaluate the parameters to determine whether the airspeed and climb rate are consistent with the detected throttle position.

If as a result of these determinations the automatic aircraft recovery system detects a fault as illustrated at 318, it can initiate recovery at operation 322. If on the other hand, no fault is detected the system can continue to monitor the aircraft parameters and evaluate parameters to detect failures that may occur as illustrated by flowline 328.

As this example illustrates, an automatic aircraft recovery system can be configured to perform fault detection by monitoring aircraft parameters for unexpected changes, out of bounds conditions, or inconsistencies among subsystems. In other embodiments, detection of a fault can be made by a human operator (e.g. a pilot). For example, the pilot may recognize through the dashboard on the remote control system conditions such as loss of power through the inability to hold altitude and airspeed, in adequate climb rate, or abnormally high throttle setting for the flight condition. In some embodiments, detection can be solely performed by human operator, solely by an automatic aircraft recovery system, or by a combination of both automated and human detection.

Likewise, initiation of the response for automatic recovery can be manual or automatic. For example, upon manual or automatic detection of a failed engine condition, the pilot may command the aircraft to initiate recovery procedure through a suitable command that can be initiated by the pilot. For example, a button or switch (e.g., mechanical, capacitive, or touchscreen) can be engaged by the pilot to initiate the recovery sequence. In some embodiments, the system can be configured such that the automatic aircraft recovery system detects the fault condition and alerts the human operator to take action, or to confirm the automated system should take action. In other embodiments, the system can be configured to be fully automatic such that operator action or confirmation is not needed.

In some embodiments, additional aircraft parameters can be examined to determine whether to initiate automatic recovery. This is illustrated at operation 320. These parameters can include, for example, altitude above ground, proximity to flight boundaries, range from the pilot, range to suitable pre-planned recovery locations (if any), and the status of any predefined parameters indicating how and when an automatic recovery should be initiated. These additional parameters may dictate configuration of the recovery plan, or may, in some circumstances, indicate automatic recovery should not be initiated. Additional Parameters may include, for example, the status of the ground under the projected flight path of the aircraft. If the ground is classified as sensitive, perhaps due to population, infrastructure, security or environmental reasons, the automatic aircraft recovery system may elect to land via a traditional ‘ditching’ where the aircraft glides until impact with the ground.

FIG. 4 is a diagram illustrating an example process for an automatic recovery to a landing configuration in accordance with one embodiment of the systems and methods disclosed herein. Referring now to FIG. 4, at operation 410 the landing plan is created. The landing plan can take into consideration aircraft parameters such as altitude, proximity to appropriate landing or recovery locations, gliding range of the aircraft, aircraft orientation, available output of faulty propulsion system (e.g., assuming less than total failure), and other parameters that can be useful in configuring a landing plan. Accordingly, in various embodiments, the landing plan can include a glide path to a recovery location and a plan to transition to VTOL propulsion for vertical landing at or near the determined recovery location.

At operation 412, the aircraft can be configured for the compromised landing. This can include, for example, configuring the aircraft for the appropriate flight conditions of the determined landing plan. This might involve configuring the aircraft into its optimum glide configuration.

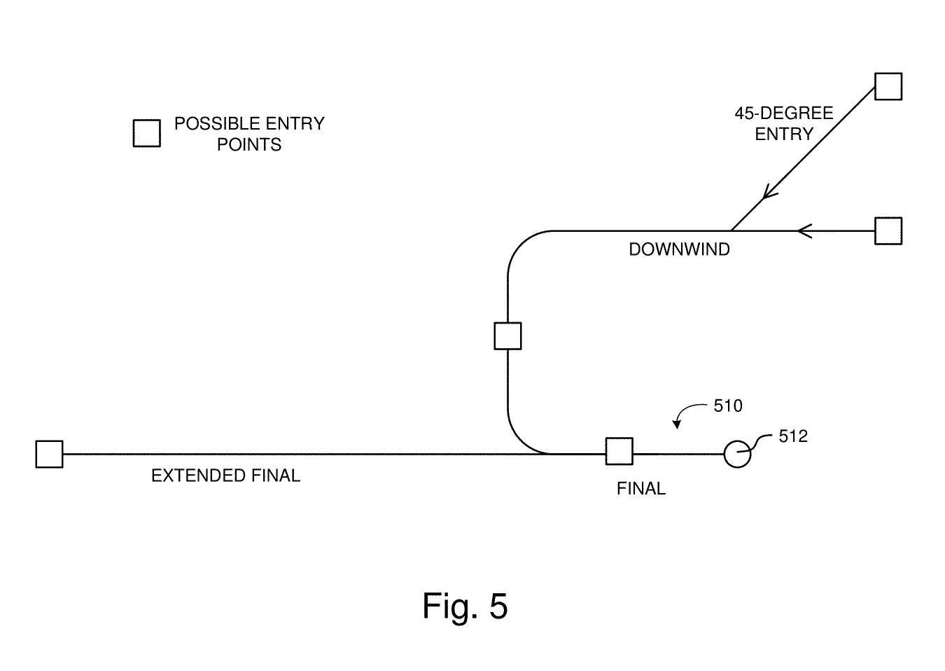

At operation 414, the landing sequence is initiated. In some embodiments, the landing sequence can be typical of that used in normal aircraft during an engine-out condition, and can further include a final approach. The landing sequence can be determined automatically such as by the automatic aircraft recovery system, but in some embodiments, the system can be configured to allow an operator to make manual adjustments to the automatically generated flight plan. One example of a landing sequence is illustrated in FIG. 5. As illustrated, the landing sequence may include a final leg or an extended final leg, a base leg, a downwind leg, a 45° entry point or other landing pattern feature typically used for aircraft, including gliders and powered aircraft. The system can further be configured to make real-time adjustments during flight to properly position the aircraft for landing at intended landing location 512. Landing pattern lengths may be shortened or lengthened, or the angles between legs adjusted to achieve the desired position, altitude, and kinetic entry upon entry into the VTOL transition leg 510.

The last segment of the landing plan typically includes a transition segment in which the aircraft maneuvers from a fixed-wing, forward-flight configuration to a primarily VTOL configuration. This transition is illustrated at operation 416 and by VTOL transition leg 510. In some embodiments, the VTOL transition segment can be identical to that normally employed by the aircraft for transition from forward propulsion to VTOL propulsion.

In some embodiments, the automatic aircraft recovery system is designed and implemented with the aircraft as part of the original aircraft design and assembly. In other embodiments, the automatic aircraft recovery system can be provided as a retrofit to existing aircraft. As noted above, in some embodiments the sensor package (including one or more sensors) and other sources of aircraft parameter information can be the same sensors and information sources as already exist in an aircraft prior to retrofitting. Similarly, the VTOL transition segment used for automatic aircraft recovery can be the same as is used to transition the aircraft prior to retrofitting. Accordingly, in such embodiments, the automatic aircraft recovery system can be configured as a plug-and-play system to the extent these pre-existing components or systems are available on the aircraft being retrofitted.

The system configured to perform the functions for automatic aircraft recovery in accordance with the technology disclosed herein can be implemented on board the aircraft or at the remote control system, or the functions can be distributed across these two platforms. The various subsystems or blocks described herein may be implemented utilizing any form of hardware, software, or a combination thereof. These may be further referred to herein as a processing block, processing module, or processor. A processing block, processing module, or processor may include, for example, one or more processors, controllers, central processing units, ASICs, PLAs, PALs, PLDs, CPLDs, FPGAs, logical components, or other mechanism or device that manipulates or operates on signals, whether analog or digital, based on hard coding or wiring of the circuitry, the execution of operational instructions, or a combination thereof.

The processing block, processing module, or processor may further include, memory (separate, integrated or embedded from the one or more processors), which may be include one or more memory devices. Such a memory device may include, for example, one or a combination of memory types such as read-only memory, random access memory, volatile and non-volatile memory, static memory, dynamic memory, flash memory, cache memory, or other information storage device, whether magnetic, acoustic, optical or otherwise.

One or more processing devices may be centrally located or may be distributed across locations (e.g., cloud computing via indirect coupling via a local area network and/or a wide area network). For example, in implementation, the various subsystems or blocks described herein might be implemented as discrete modules or the functions and features described can be shared in part or in total among one or more processing modules. In other words, as would be apparent to one of ordinary skill in the art after reading this description, the various features and functionality described herein may be implemented in any given application and can be implemented in one or more separate or shared processing modules in various combinations and permutations. Even though various features or elements of functionality may be individually described or claimed as separate subsystems or blocks, one of ordinary skill in the art will understand that these features and functionality can be shared among one or more common software and hardware elements, and such description shall not require or imply that separate hardware or software components are used to implement such features or functionality.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that can be included in the disclosed technology. The disclosed technology is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the technology disclosed herein. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. An aircraft, comprising:
a forward propulsion system comprising a first engine and a first rotor coupled to the first engine;
a vertical propulsion system comprising a second engine and a second rotor coupled to the second engine;
a sensor package comprising one or more sensors to detect an operating parameter of the aircraft;
an automatic recovery system, comprising:
an input coupled to the sensor package;
an output coupled to an aircraft controller;
a processor to monitor one or more operating parameters of the aircraft, detect a failure of the forward propulsion system based on the operating parameters, and transition the aircraft to the vertical propulsion system for landing.

2. The aircraft of claim 1, wherein the operating parameter includes at least one of RPM, altitude, airspeed, climb rate, and throttle setting.

3. The aircraft of claim 1, wherein the aircraft is an unmanned aircraft.

4. The aircraft of claim 1, wherein the processor is further configured to perform the operations of creating a landing plan for the aircraft up detection of a failure of the forward propulsion system.

5. The aircraft of claim 4, wherein the processor is further configured to configure the aircraft for compromised landing.

6. The aircraft of claim 4, wherein the landing plan created for the aircraft is created based on aircraft altitude and location at the time of creating the landing plan.

7. The aircraft of claim 1, wherein detecting a failure comprises at least one of detecting a loss of RPM from the first engine, detecting a loss of altitude or airspeed, detecting an in adequate climb rate, and detecting an abnormally high throttle setting for a flight condition.

8. The aircraft of claim 1, wherein first and second engines each comprise at least one of an internal combustion engine and a motor.

9. The aircraft of claim 1, wherein the aircraft is a multirotor aircraft and the vertical propulsion system comprises a plurality of engines and corresponding rotors.

10. The aircraft of claim 1, wherein the aircraft is a hybrid multirotor aircraft.

11. An unmanned aircraft system, comprising:
an unmanned aircraft, comprising:
a forward propulsion system comprising a first engine and a first rotor coupled to the first engine;
a vertical propulsion system comprising a second engine and a second rotor coupled to the second engine;
a sensor package comprising one or more sensors to detect an operating parameter of the aircraft;
an onboard aircraft controller comprising a first output coupled to the forward propulsion system and a second output coupled to the vertical propulsion system; and
a first communication transceiver coupled to the aircraft controller and configured to communicate with a remote control system;
the remote control system, comprising:
a second communication transceiver configured to communicate with the unmanned aircraft; and
an aircraft control system communicatively coupled to the second communication transceiver; and
an automatic recovery system, comprising:
an input coupled to the sensor package;
an output coupled to an aircraft controller;
a processor to monitor one or more operating parameters of the aircraft, detect a failure of the forward propulsion system based on the operating parameters, and transition the aircraft to vertical propulsion system flight for landing.

12. The unmanned aircraft system of claim 11, wherein the automatic recovery system is part of the onboard aircraft controller.

13. The unmanned aircraft system of claim 11, wherein the automatic recovery system is part of the aircraft control system of the remote control system.

14. The unmanned aircraft system of claim 11, wherein the automatic recovery system is part of both the onboard aircraft controller the aircraft control system of the remote control system.

15. The unmanned aircraft system of claim 11, wherein the operating parameter includes at least one of RPM, altitude, airspeed, climb rate, and throttle setting.

16. The unmanned aircraft system of claim 11, wherein the processor is further configured to perform the operations of creating a landing plan for the aircraft upon detection of a failure of the forward propulsion system.

17. The unmanned aircraft system of claim 16, wherein the processor is further configured to configure the aircraft for compromised landing.

18. The unmanned aircraft system of claim 16, wherein the landing plan created for the aircraft is created based on aircraft altitude and location at the time of creating the landing plan.

19. The unmanned aircraft system of claim 11, wherein detecting a failure comprises at least one of detecting a loss of RPM from the first engine, detecting a loss of altitude or airspeed, detecting an in adequate climb rate, and detecting an abnormally high throttle setting for a flight condition.

20. The unmanned aircraft system of claim 11, wherein first and second engines each comprise at least one of an internal combustion engine and a motor.

21. The unmanned aircraft system of claim 11, wherein the aircraft is a multirotor aircraft and the vertical propulsion system comprises a plurality of engines and corresponding rotors.

22. A method for automatic recovery of an aircraft, comprising:
monitoring aircraft parameters;
detecting a failure of a forward propulsion system of the aircraft based on the operating parameters; and
transitioning the aircraft to a vertical propulsion system for landing.

23. The method of claim 22, wherein the operating parameter includes at least one of RPM, altitude, airspeed, climb rate, and throttle setting.

24. The method of claim 22, wherein the aircraft is an unmanned aircraft.

25. The method of claim 22, further comprising creating a landing plan for the aircraft up detection of a failure of the forward propulsion system.

26. The method of claim 25, wherein the processor is further configured to configure the aircraft for compromised landing.

27. The method of claim 25, wherein the landing plan created for the aircraft is created based on aircraft altitude and location at the time of creating the landing plan.

28. The method of claim 22, wherein detecting a failure comprises at least one of detecting a loss of RPM from the first engine, detecting a loss of altitude or airspeed, detecting an in adequate climb rate, and detecting an abnormally high throttle setting for a flight condition.
